(19) United States
(12) Patent Application Publication
(10) Pub. No.: US 2026/0184592 A1
(43) Pub. Date: Jul. 2, 2026

(54) MATERIAL WITH DUAL HETEROGENEOUS STRUCTURE, PREPARATION METHOD AND APPLICATION THEREOF

(71) Applicant: JIANGSU UNIVERSITY, Jiangsu (CN)

(72) Inventors: Xinlin LIU, Jiangsu (CN); Peng LYU, Jiangsu (CN); Haixia LIU, Jiangsu (CN); Liguang TANG, Jiangsu (CN); Yu GU, Jiangsu (CN); Jiaqi WANG, Jiangsu (CN); Yangrui XU, Jiangsu (CN); Guosheng ZHOU, Jiangsu (CN); Ziyang LU, Jiangsu (CN); Jie JIN, Jiangsu (CN)

(73) Assignee: JIANGSU UNIVERSITY, Jiangsu (CN)

(21) Appl. No.: 18/865,680

(22) PCT Filed: Aug. 9, 2024
(86) PCT No.: PCT/CN2024/110987

§ 371 Date: Nov. 14, 2024

(30) Foreign Application Priority Data
Sep. 5, 2023 (CN) 202311136362.9

(51) Int. Cl. C01G 29/00

(52) U.S. Cl. CPC C01G 29/006; C01P 2002/72; C01P 2002/84; C01P 2004/03; C01P 2004/04; C01P 2004/32; C01P 2004/61; C01P 2004/64

(57) ABSTRACT

This application discloses material with dual heterogeneous structure, preparation method and application thereof. The material with dual heterogeneous structure is CdS/Bi₂S₃/ZnS composite material. With spherical Bi₂S₃ as the carrier, CdS particles and ZnS particles are uniformly dispersed on the surface of Bi₂S₃ to form a dual heterogeneous structure. The preparation method of the material with dual heterogeneous structure, comprising: dissolving Bi (NO₃)₃·5H₂O in ethylene glycol solution to obtain Solution A; dissolving ZnCl₂ in water to obtain solution B; dissolving CdCl₂·2.5H₂O in water to obtain solution C; mixing the solution A, B and C, and adding L-cysteine to the mixture. After hydrothermal reaction, washing and drying, CdS/Bi₂S₃/ZnS composite material is obtained. The material with dual heterogeneous structure can be applied in photocatalytic reduction of carbon dioxide, which selectively reduces carbon dioxide to CH₄.

### CROSS-REFERENCE TO RELATED APPLICATION

The present application claims priority to Chinese patent application NO. 202311136362.9, filed to the Chinese Patent Office on Sep. 5, 2023, entitled “photocatalyst with dual heterogeneous structure, preparation method and application thereof”, the entire disclosure of which is incorporated herein by reference.

### TECHNICAL FIELD

The application relates to the field of composite material, and in particular, to material with dual heterogeneous structure, preparation method and application thereof.

### RELATED ART

As the world has entered the era of industrialization, human demand for fossil fuels has increased. The excessive use of fossil fuels has caused serious energy crisis and environmental pollution. The burning of fossil fuels emits a large amount of carbon dioxide, which is the main greenhouse gas leading to global warming. In order to solve the energy crisis and environmental problems, it has been found that photocatalytic reduction reaction can convert carbon dioxide into renewable fuels, which can not only reduce carbon dioxide emissions, but also provide useful energy sources. It is of great significance in alleviating the energy crisis and dealing with environmental pollution.

Photocatalytic method can use solar energy as a driving force to effectively reduce energy loss, and use the photogenerated electrons of photocatalyst to reduce carbon dioxide. However, due to the fast recombination rate of electron-hole pairs and the low utilization rate of photogenerated electrons, the wide application of photocatalysts is limited. As a semiconductor photocatalyst, metal sulfide has been widely studied in the field of photocatalysis. Because of its unique electronic properties and light absorption and conversion ability, it has become one of the most promising photocatalytic materials. The metal sulfide contains the S 3p orbital to make it have a narrower energy band position, and the corresponding hole mass is smaller, with a stronger quantum size effect, which is conducive to the transfer and separation of photogenerated carriers. However, in the reduction reaction of CO₂, it combines with electrons to generate various reduction products, such as CO and CH₄. Although photocatalytic reduction of CO₂ to CH₄ is thermodynamically favorable, it is difficult for most photocatalysts to achieve high selectivity for CH₄ generation. The selectivity is uncontrollable, and the key is that the binding ability between the reaction intermediate and the material is difficult to control.

In recent years, researchers have used various strategies to improve the selectivity of CH₄, such as surface modification, ion doping and metal cocatalyst. However, the experimental process of these common control methods is cumbersome, and it is often necessary to add some surface modifiers or more expensive metal cocatalysts as auxiliary conditions, which lacks economic benefits. Therefore, it is of great value to provide a selective photocatalyst for the reduction of CO₂ to CH₄ and its efficient preparation method.

### SUMMARY OF INVENTION

Based on the above technical problems, this application provides a material with dual heterogeneous structure, preparation method and application thereof. The photocatalyst uses spherical Bi₂S₃ as the carrier, CdS particles and ZnS particles are uniformly dispersed on the surface of Bi₂S₃, forming a dual heterogeneous structure and Cd—Zn—Bi ternary metal active site, which effectively promotes the separation of photogenerated electron-hole pairs, improves the utilization rate of photogenerated charges, and can selectively reduce CO₂ to CH₄.

The specific scheme of this application is as follows.

One of the purposes of this application is to provide a material with dual heterogeneous structure. The material with dual heterogeneous structure is CdS/Bi₂S₃/ZnS composite material. With spherical Bi₂S₃ as the carrier, CdS particles and ZnS particles are uniformly dispersed on the surface of Bi₂S₃ to form a dual heterogeneous structure. A molar ratio of ZnS, Bi₂S₃ and CdS in the CdS/Bi₂S₃/ZnS composite material is 3:1:0.1-5.

Wherein, the diameter of spherical Bi₂S₃ is 1-3 μm, the diameter of CdS particles is 20-100 nm, and the diameter of ZnS particles is 20-100 nm.

Wherein, a molar ratio of ZnS, Bi₂S₃ and CdS in the CdS/Bi₂S₃/ZnS composite material is 3:2:0.9-2.

The material with dual heterogeneous structure described in this application uses spherical Bi₂S₃ as the carrier, and CdS particles and ZnS particles are uniformly dispersed on the surface of Bi₂S₃ to form a dual heterogeneous structure, which effectively promotes the separation of photogenerated electron-hole pairs and improves the utilization of photogenerated charges. At the same time, due to the interaction between Cd atoms and Zn—Bi atoms, the Cd—Zn—Bi ternary metal reaction site is formed, which can effectively inhibit the shedding of the reaction intermediate CO* during the photocatalytic reduction of CO₂, promote its further hydrogenation to produce CH₄, and selectively reduce CO₂ to CH₄.

The second purpose of this application is to provide a preparation method of the material with dual heterogeneous structure, comprising: Bi (NO₃)₃·5H₂O is dissolved in ethylene glycol solution to obtain Solution A. ZnCl₂ is dissolved in water to obtain solution B. CdCl₂·2.5H₂O is dissolved in water to obtain solution C. The solution A, B and C are mixed, and L-cysteine is added to the mixture. After hydrothermal reaction, washing and drying, CdS/Bi₂S₃/ZnS composite material is obtained. A molar ratio of ZnCl₂, Bi (NO₃)₃·5H₂O and CdCl₂·2.5H₂O in the mixture is 3:2:0.1-5.

In this application, the material with dual heterogeneous structure is synthesized by one-step hydrothermal method. By adjusting the proportion of metal synthesis, a special ternary metal reaction active site is formed, which effectively improves the selectivity of carbon dioxide reduction products. The preparation method is simple, practical and economical.

Wherein, the molar ratio of ZnCl₂, Bi(NO₃)₃·5H₂O and CdCl₂·2.5H₂O in the mixture is 3:2:0.9-2.

Wherein, the molar ratio of L-cysteine to CdCl₂·2.5H₂O in the mixture is 25:0.1-5.

Wherein, the hydrothermal reaction temperature is 160-200° C., and the hydrothermal reaction time is 18-26 h.

Wherein, in the solution A, the concentration of Bi(NO₃)₃·5H₂O is 1-5 mmol:30 mL. In the solution B, the concentration of ZnCl₂ is 1-5 mmol:20 mL. In the solution C, the concentration of CdCl₂·2.5H₂O is 0.1-5 mmol:30 mL. Preferably, in the solution C, the concentration of CdCl₂·2.5H₂O is 0.9-2 mmol:30 mL.

The third purpose of this application is to provide the application of the material with dual heterogeneous structure or the material with dual heterogeneous structure prepared by any of the above methods in photocatalytic reduction of carbon dioxide.

Wherein, the material with dual heterogeneous structure selectively reduces carbon dioxide to CH₄.

The beneficial effects of this application are as follow.

The photocatalyst provided in this application is CdS/Bi₂S₃/ZnS composite material. With spherical Bi₂S₃ as the carrier, CdS particles and ZnS particles are uniformly dispersed on the surface of Bi₂S₃ to form a dual heterogeneous structure and ternary metal active sites, which can effectively improve the utilization rate of photogenerated electrons, regulate the reduction path of carbon dioxide, and make carbon dioxide more inclined to convert into high value-added hydrocarbons such as methane.

Compared with the existing Bi₂S₃/ZnS composite photocatalyst, the addition of Cd metal adjusts the reduction path of CO₂, thereby enhancing the selectivity of CH₄. The yield of CH₄ is up to 145.08 μmol g⁻¹ h⁻¹, which is 5.54 times, 14.1 times and 27.16 times higher than that of pure CdS, Bi₂S₃ and ZnS under the same reaction conditions. The electron selectivity of CH₄ reached 94.2%.

### BRIEF DESCRIPTION OF DRAWINGS

FIG. 1 is the SEM image of different samples, wherein (a) is ZnS obtained by Comparative Example 2, (b) is CdS obtained by Comparative Example 4, and (c) is Bi₂S₃ obtained by Comparative Example 3, and (d) is CdS/Bi₂S₃/ZnS composite obtained by Embodiment 1.

FIG. 2 is the HRTEM image of CdS/Bi₂S₃/ZnS composite obtained by Embodiment 1, wherein (a) is CdS/Bi₂S₃/ZnS, (b) is CdS, corresponding to region 1 in (a), (c) is ZnS, corresponding to region 2 in (a), (d) is the inverse Fourier transform diagram of (b), (e) is the inverse Fourier transform diagram of (c), and (f) is the inverse Fourier transform diagram of (d).

FIG. 3 is the XRD pattern of different samples obtained by Embodiment 1 and Comparative Examples 2-4.

FIG. 4 is the UV-visible diffuse reflectance spectra of different samples obtained by Embodiment 1 and Comparative Examples 2-4.

FIG. 5 is the cycle characteristic of CdS/Bi₂S₃/ZnS for CO₂ reduction obtained by Embodiment 1.

### DESCRIPTION OF EMBODIMENTS

In the following, this application explains the technical scheme in detail through specific embodiments, but these embodiments should be clearly put forward for illustration, but they are not interpreted as limiting the scope of this application.

### Embodiment 1

This embodiment proposes a material with dual heterogeneous structure, which is CdS/Bi₂S₃/ZnS composite material. With spherical Bi₂S₃ as the carrier, CdS particles and ZnS particles are uniformly dispersed on the surface of Bi₂S₃ to form a dual heterogeneous structure. Wherein, the diameter of spherical Bi₂S₃ is 1-3 μm, the diameter of CdS particles is 20-100 nm, and the diameter of ZnS particles is 20-100 nm. The molar ratio of ZnS, Bi₂S₃ and CdS in CdS/Bi₂S₃/ZnS composite material is 3:2:1.8.

The preparation method of the material with dual heterogeneous structure comprises the steps as follows. 2 mmol bismuth nitrate pentahydrate (Bi(NO₃)₃·5H₂O) was weighed into a beaker A. 30 mL deionized water was measured into the beaker A, which marked as A solution. And then the A solution was stirred at room temperature for 1 hour until it is clear. 3 mmol zinc chloride (ZnCl₂) was weighed into a beaker B. 20 mL deionized water was measured into the beaker B, which marked as B solution. The solution was ultrasounded for 30 min, and then stirred at room temperature for 30 min. 1.8 mmol cadmium chloride (CdCl₂·2.5H₂O) was weighed into a beaker C. 30 mL deionized water was measured into the beaker C, which marked as C solution. And then the C solution was stirred at room temperature for 1 hour until it is clear.

The solution A, B and C were poured into a beaker in turn under stirring conditions, and the mixed solution became white opaque and stirred for 5 min. 25 mmol L-cysteine was weighed into a beaker and stirred for 1 h. Then the stirred mixture was transferred to a hydrothermal kettle and sealed, placed in an oven, and reacted at 180° C. for 22 h. After the reactant was cooled to room temperature, the precipitate in the reactor was taken out and washed several times with deionized water and ethanol. The obtained product was dried in an oven at 60° C. for 12 h.

### Embodiment 2

This embodiment proposes a material with dual heterogeneous structure. The difference between the preparation method of this embodiment and the Embodiment 1 is that, the amount of cadmium chloride is adjusted from “1.8 mmol” to “0.1 mmol”, and the other steps and parameters are the same as those in the Embodiment 1.

### Embodiment 3

This embodiment proposes a material with dual heterogeneous structure. The difference between the preparation method of this embodiment and the Embodiment 1 is that, the amount of cadmium chloride is adjusted from “1.8 mmol” to “0.9 mmol”, and the other steps and parameters are the same as those in the Embodiment 1.

### Embodiment 4

This embodiment proposes a material with dual heterogeneous structure. The difference between the preparation method of this embodiment and the Embodiment 1 is that, the amount of cadmium chloride is adjusted from “1.8 mmol” to “2 mmol”, and the other steps and parameters are the same as those in the Embodiment 1.

### Embodiment 5

This embodiment proposes a material with dual heterogeneous structure. The difference between the preparation method of this embodiment and the Embodiment 1 is that, the amount of cadmium chloride is adjusted from “1.8 mmol” to “5 mmol”, and the other steps and parameters are the same as those in the Embodiment 1.

### Comparative Example 1

This embodiment proposes a CuS/Bi₂S₃/ZnS composite photocatalyst. The difference between the preparation method of this embodiment and the Embodiment 1 is that, 1.8 mmol cadmium chloride (CdCl₂·2.5H₂O) was replaced by 1.8 mmol copper nitrate (Cu(NO₃)₂·3H₂O), and the other steps and parameters are the same as those in the Embodiment 1.

### Comparative Example 2

This embodiment proposes a ZnS photocatalyst, the synthesis method of which comprises the steps as follows.

3 mmol of zinc chloride was dissolved in 20 mL of deionized water. The solution was placed in an ultrasonic cleaner ultrasound for 30 min, then stirred at room temperature for 30 min, until the solution turned milky white. Then 25 mmol L-cysteine was poured into the solution and stirred at room temperature for 1 h until the solution was transparent. The mixed solution was transferred to a sealed PTFE-lined stainless steel autoclave and reacted in an oven at 180° C. for 22 hours. After the reactant was cooled to room temperature, the precipitate in the reactor was taken out and washed several times with deionized water and ethanol. The obtained product was dried in an oven at 60° C. for 10 h to obtain a ZnS.

### Comparative Example 3

This embodiment proposes a Bi₂S₃ photocatalyst, the synthesis method of which comprises the steps as follows.

2 mmol bismuth nitrate pentahydrate was weighed in a beaker. 30 mL deionized water was measured and slowly poured into the beaker, and stirred for 1 h at room temperature to clarify it. Then 25 mmol L-cysteine was poured into the mixed solution and stirred at room temperature for 1 h until the solution was green and transparent. The mixed solution was then transferred to a 100 mL PTFE-lined stainless steel autoclave sealed and reacted in an oven at 180° C. for 22 hours. After the reactant was cooled to room temperature, the precipitate in the reactor was taken out and washed several times with deionized water and ethanol. The obtained product was dried in an oven at 60° C. for 12 h to obtain a Bi₂S₃.

### Comparative Example 4

This embodiment proposes a CdS photocatalyst, the synthesis method of which comprises the steps as follows.

1.8 mmol cadmium chloride (CdCl₂·2.5H₂O) was weighed into a washed beaker. 30 mL deionized water was measured and slowly poured into the beaker, and stirred for 1 h at room temperature to clarify it. Then 25 mmol L-cysteine was poured into the mixed solution and stirred at room temperature for 1 h until the solution was green and transparent. The mixed solution was then transferred to a 100 mL PTFE-lined stainless steel autoclave sealed and reacted in an oven at 180° C. for 22 hours. After the reactant was cooled to room temperature, the precipitate in the reactor was taken out and washed several times with deionized water and ethanol. The obtained product was dried in an oven at 60° C. for 12 h to obtain a CdS.

The photocatalytic activity of the photocatalysts obtained by the above embodiments and the Comparative Examples was tested. The test method and test results are as follows.
(1) The photocatalyst activity evaluation is as follows. The CO₂ reduction activity of the photocatalyst was tested in a 100 mL stainless steel reactor with a 300 W xenon lamp as the light source and a working current of 21 A. The composite material (10 mg) was uniformly dispersed in quartz glass, 18 mL deionized water was used as solvent, and 2 mL TEOA was used as sacrificial agent. After 5 mins of ultrasonic vibration, it was transferred to a stainless steel reactor. Before the photoreduction of CO₂ experiment, the high purity CO₂ gas (99.995%) was used to ventilate for 2 h, and the air in the reactor was discharged. Then the valve at one end of the reactor was closed, carbon dioxide was passed to a pressure of 4 bar. The xenon lamp was turned on, and samples were taken and analyzed at intervals of 1 h during the illumination process, and gas products were detected by gas chromatography (GC-2030).
(2) The yields of the reduced products CO and CH4 were measured after 5 hours of illumination, as shown in Table 1.

TABLE 1
The yields of the reduced products CO and CH₄

| | The yield of CO | The yield of CH₄ | The electron selectivity |
|---|---|---|---|
| | (μmol g⁻¹h⁻¹) | (μmol g⁻¹h⁻¹) | of CH₄ (%) |
| Embodiment 1 | 35.49 | 145.08 | 94.2% |
| Embodiment 2 | 89.58 | 18.15 | 44.8% |
| Embodiment 3 | 34.29 | 34.54 | 80.1% |
| Embodiment 4 | 34.20 | 68.84 | 89.1% |
| Embodiment 5 | 27.72 | 5.38 | 43.7% |
| Comparative Example 1 | 72.8 | 13.2 | 42.03% |
| Comparative Example 2 | 74.00 | 5.34 | 21.4% |
| Comparative Example 3 | 64.70 | 10.29 | 38.9% |
| Comparative Example 4 | 139.59 | 26.15 | 42.8% |

The selectivity calculation formula is as follows: CH₄ selectivity (%)=[8φ(CH₄)]/[2φ(CO)+8φ(CH₄)]×100. Wherein, φ(CO) is the yield of CO per hour, and φ(CH₄) is the yield of CH₄ per hour.

It can be seen from the contrast of the data of the Embodiment 1 and the Comparative Example 1 that, the cadmium chloride in the Embodiment 1 is replaced by copper nitrate in the Comparative Example 1, and the CH₄ electron selectivity of the obtained composite photocatalyst is only 42.03% in the Comparative Example 1, which is much smaller than 94.2% of the Embodiment 1. This shows that not any material that can be combined with Bi₂S₃ to obtain a heterojunction structure can be selectively reduced to CH₄ by introducing Bi₂S₃/ZnS.

By comparing the data of Embodiment 1-5, it can be seen that CH₄ electron selectivity of embodiments 1, 3, 4 is 94.2%, 80.1% and 89.1%, respectively, which is much higher than that of embodiments 2 and 5. It shows that the molar ratio of CdS, Bi₂S₃ and ZnS has a significant effect on the selectivity of the material with dual heterogeneous structure.

The other test results of the above embodiments and Comparative Examples obtained by the ratio are as follows.

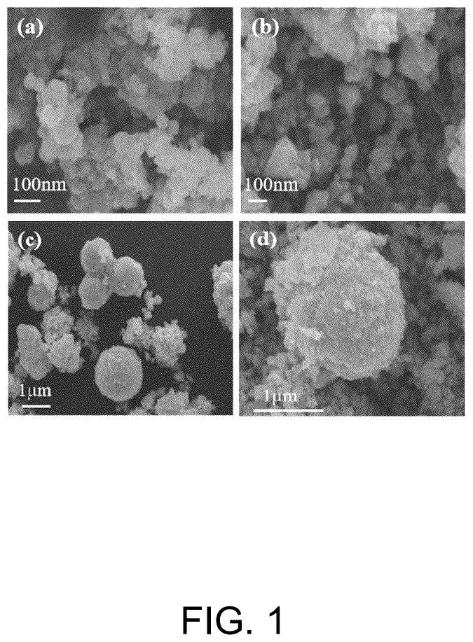

FIG. 1 is the SEM image of different samples, wherein (a) is ZnS obtained by the Comparative Example 2, (b) is CdS obtained by the Comparative Example 4, and (c) is Bi₂S₃ obtained by the Comparative Example 3, and (d) is CdS/Bi₂S₃/ZnS composite obtained by the Embodiment 1.

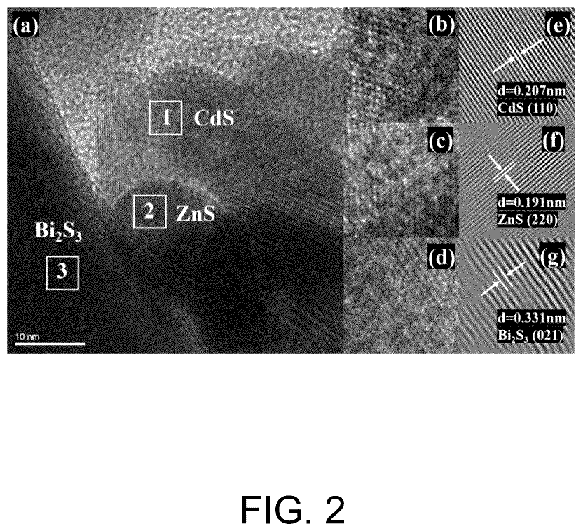

FIG. 2 is the HRTEM image of CdS/Bi₂S₃/ZnS composite obtained by the Embodiment 1, wherein (a) is CdS/Bi₂S₃/ZnS, (b) is CdS, corresponding to region 1 in (a), (c) is ZnS, corresponding to region 2 in (a), (d) is the inverse Fourier transform diagram of (b), (e) is the inverse Fourier transform diagram of (c), and (f) is the inverse Fourier transform diagram of (d).

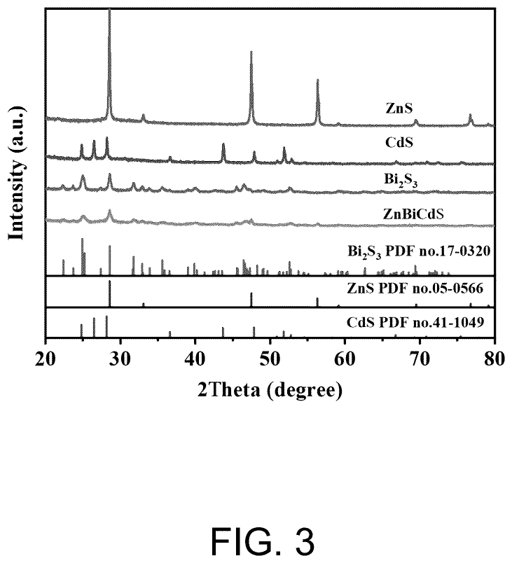

FIG. 3 is the XRD pattern of different samples obtained by the Embodiment 1 and Comparative Examples 2-4. Wherein, ZnS corresponds to the sample of the Comparative Example 2, CdS corresponds to the sample of the Comparative Example 4, Bi₂S₃ corresponds to the sample of the Comparative Example 3, and ZnBiCdS corresponds to the CdS/Bi₂S₃/ZnS composite obtained by the Embodiment 1.

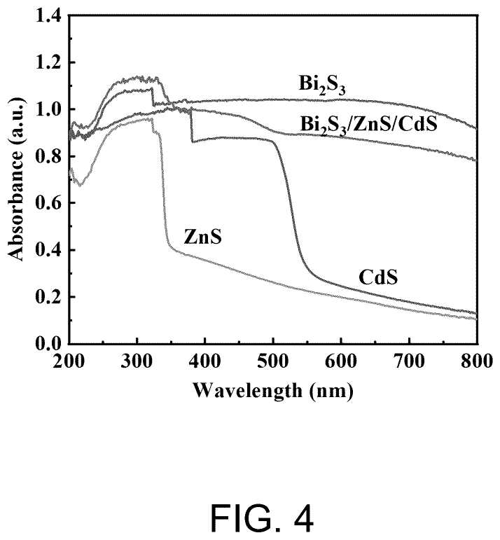

FIG. 4 is the UV-visible diffuse reflectance spectra of different samples obtained by the Embodiment 1 and Comparative Examples 2-4. Wherein, ZnS corresponds to the sample of the Comparative Example 2, CdS corresponds to the sample of the Comparative Example 4, Bi₂S₃ corresponds to the sample of the Comparative Example 3, and ZnBiCdS corresponds to the CdS/Bi₂S₃/ZnS composite obtained by the Embodiment 1.

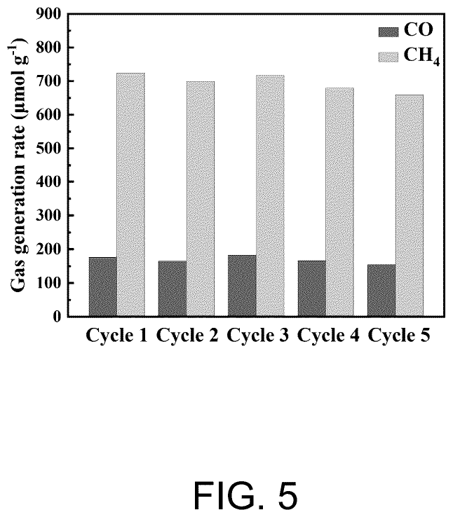

FIG. 5 is the cycle characteristic of CdS/Bi₂S₃/ZnS for CO₂ reduction obtained by the Embodiment 1.

The above is only the preferred embodiment of the present application, but the scope of protection of the present application is not limited thereto, and any equivalents or modifications of the technical solutions of the present application and the application concept thereof should be comprised in the scope of the present application within the scope of the technical scope of the present application.

1. A material with dual heterogeneous structure, wherein the material with dual heterogeneous structure is CdS/Bi₂S₃/ZnS composite material, with spherical Bi₂S₃ as the carrier, CdS particles and ZnS particles are uniformly dispersed on the surface of Bi₂S₃ to form a dual heterogeneous structure; a molar ratio of ZnS, Bi₂S₃ and CdS in the CdS/Bi₂S₃/ZnS composite material is 3:1:0.1-5.

2. The material with dual heterogeneous structure according to claim 1, wherein, the diameter of spherical Bi₂S₃ is 1-3 m, the diameter of CdS particles is 20-100 nm, and the diameter of ZnS particles is 20-100 nm.

3. The material with dual heterogeneous structure according to claim 1, wherein, a molar ratio of ZnS, Bi₂S₃ and CdS in the CdS/Bi₂S₃/ZnS composite material is 3:1:0.9-2.

4. A preparation method of the material with dual heterogeneous structure, comprising: dissolving Bi(NO₃)₃·5H₂O in ethylene glycol solution to obtain Solution A; dissolving ZnCl₂ in water to obtain solution B; dissolving CdCl₂ 2.5H₂O in water to obtain solution C; mixing the solution A, B and C, and adding L-cysteine to the mixture; after hydrothermal reaction, washing and drying, obtaining CdS/Bi₂S₃/ZnS composite material; wherein a molar ratio of ZnCl₂, Bi (NO₃)₃ 5H₂O and CdCl₂ 2.5H₂O in the mixture is 3:2:0.1-5.

5. The preparation method of the material with dual heterogeneous structure according to claim 4, wherein, a molar ratio of ZnCl₂, Bi(NO₃)₃·5H₂O and CdCl₂ 2.5H₂O in the mixture is 3:2:0.9-2.

6. The preparation method of the material with dual heterogeneous structure according to claim 4, wherein, a molar ratio of L-cysteine to CdCl₂ 2.5H₂O in the mixture is 25:0.1-5.

7. The preparation method of the material with dual heterogeneous structure according to claim 4, wherein, the hydrothermal reaction temperature is 160-200° C., and the hydrothermal reaction time is 18-26 h.

8. The preparation method of the material with dual heterogeneous structure according to claim 4, wherein, in the solution A, a concentration of Bi(NO₃)₃·5H₂O is 1-5 mmol:30 mL; in the solution B, a concentration of ZnCl₂ is 1-5 mmol:20 mL; in the solution C, a concentration of CdCl₂ 2.5H₂O is 0.1-5 mmol:30 mL.

9. (canceled)

10. (canceled)

11. (canceled)

12. (canceled)
